(19) United States
(12) Patent Application Publication
(10) Pub. No.: US 2026/0049230 A1
(43) Pub. Date: Feb. 19, 2026

(54) COMPOSITIONS FOR RESTORING AND PROTECTING VINYL, RUBBER, AND PLASTIC SURFACES

(71) Applicant: Energizer Auto, Inc., St. Louis, MO (US)

(72) Inventors: Karen Marie Grabiec, Olmsted Township, OH (US); Matthew MacKay Nathal, Strongville, OH (US)

(73) Assignee: Energizer Auto, Inc., St. Louis, MO (US)

(21) Appl. No.: 19/301,740

(22) Filed: Aug. 15, 2025

Related U.S. Application Data
(60) Provisional application No. 63/683,517, filed on Aug. 15, 2024.

(51) Int. Cl. C09D 183/04; C08J 7/04; C09D 7/20; C09D 7/63; C09D 7/65; C09D 7/80

(52) U.S. Cl. CPC C09D 183/04; C08J 7/0427; C09D 7/20; C09D 7/63; C09D 7/65; C09D 7/80; C08J 2321/00; C08J 2357/00; C08J 2483/04

(57) ABSTRACT

The present disclosure describes compositions for restoring and protecting vinyl, rubber, and plastic (VRP) surfaces, wherein the compositions include at least two silicone fluids. In embodiments, the compositions include a first silicone fluid and a second silicone fluid, one or more mineral oils, one or more rheology modifiers, one or more hydrocarbon solvents, water, and optionally one or more preservatives. The present disclosure also describes a method of preparing the composition, wherein the method includes slowly adding the one or more hydrocarbon solvents to the water that is moving at a slow speed to form a solution, continuing mixing, and adding the one or more rheology modifiers to the solution and mixing, continuing mixing and adding to the solution in the following order: the one or more mineral oils; the first silicone fluid, the silicone second fluid, and optionally adding the one or more preservatives and continue mixing.

### CROSS-REFERENCE TO RELATED APPLICATIONS

This application claims the benefit of U.S. Provisional Application No. 63/683,517, filed Aug. 15, 2024, which is incorporated herein by reference in its entirety.

### FIELD OF THE DISCLOSURE

The present disclosure discloses compositions in a liquid form for restoring and protecting surfaces including interior and exterior vinyl, rubber, and plastic (VRP) surfaces of vehicles. The present disclosure also discloses methods for preparing the compositions and methods for restoring and protecting surfaces using the compositions.

### BACKGROUND OF THE DISCLOSURE

The vinyl, rubber, and plastic (VRP) surfaces found both inside and outside vehicles are an important aspect of vehicle structure, appearance, and quality. Internally, VRP surfaces serve as integral components of user interfaces, including dashboards, door linings, consoles, and compartments, offering users both aesthetically appealing and functional environments. Moreover, they provide necessary separation and protection for internal electronics, mechanics, bare metal, and other delicate or potentially harmful components. Similarly, exterior VRP surfaces provide important structural and aesthetic functions. Exterior VRP surfaces including the surfaces of bumpers, rocker panels, vehicle, and door trim weather stripping cover and protect bare metal, mechanics, and other critical vehicle parts from weather and environmental hazards, while also contributing to aerodynamic efficiency and visual appeal.

Unfortunately, these VRP surfaces are constantly exposed to harsh conditions during normal use, including sun exposure (UVA/UVB radiation), temperature extremes, moisture, dirt, abrasion, and general wear and tear. The degradation of VRP materials can significantly compromise their functionality and safety, leading to brittleness, cracking, or breakage. Additionally, this degradation manifests as color fading, dullness, cracks, and accelerated wear and tear, adversely affecting the vehicle's appearance. Since appearance plays a pivotal role in shaping consumers' perceptions of quality, preserving the integrity of VRP surfaces, as well as their aesthetic appeal, are paramount for maintaining a vehicle's overall appeal and value.

The current VRP protectants on the market involve formulations and application methods to address the appearance, durability, and longevity of interior and exterior surfaces in automobiles. Many of these VRP protectants, however, may leave behind residue or build up over time. This can result in a sticky or greasy feel and attract dust and debris, detracting from the appearance of treated surfaces. Current VRP protectants also struggle to provide long-lasting protection, where their effectiveness can diminish over time, particularly in extreme conditions such as intense sunlight or harsh weather, requiring periodic reapplication to maintain optimal performance and appearance.

Improper application techniques and sub-optimal formulations can lead to uneven coverage, streaks, and/or a blotchy appearance. Therefore, there is a need for advanced compositions and methods to protect and rejuvenate vinyl, rubber, and plastic surfaces. Specifically, long-lasting formulations include UV inhibitors to prevent sun damage, anti-static agents to repel dust, and conditioners to restore flexibility and prevent cracking.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes compositions including components that interact together to form restoring and protecting compositions for vinyl, rubber, and plastic (VRP) surfaces. Compositions of the present disclosure (VRP compositions) may create a “like-new” appearance when applied to VRP surfaces, restoring color depth, and providing a high shine while being non-greasy and dry to the touch. Compositions of the present disclosure may provide protection when applied to VRP surfaces, penetrating pores of the surfaces to provide a barrier of protection from dirt, water, and harmful solar radiation (UVA/UVB). Compositions of the present disclosure may provide heavy-duty and long-lasting protection, for example, for 13 or more washes and/or for a year or more.

The components of the compositions described herein include at least two silicone fluids, one or more mineral oils, one or more rheology modifiers, and one or more solvents, wherein the one or more solvents include at least water and one or more organic solvents. In embodiments, the one or more solvents include a hydrocarbon solvent, such as hydrotreated light petroleum distillates. Optionally, the compositions described herein include one or more preservatives.

In embodiments, the compositions described herein include deionized water, silicone fluid of about 350 cSt, silicone fluid of about 12,500 cSt, mineral oil obtained from petrochemicals, acrylate, and acrylamide copolymers, a mixture of hydrotreated isoparaffins and naphthenics, and optionally a preservative including benzisothiazolinone.

In embodiments, the present disclosure describes a method of preparing the compositions described herein. The method includes: adding one or more hydrocarbon solvents to water and mixing at a slow speed to form a solution; continuing mixing the solution for a period of time, and optionally increasing the speed; continuing mixing and adding the one or more rheology modifiers to the solution and mixing for a period of time; continue mixing and adding to the solution in the following order one or more mineral oils and one or more silicone fluids, wherein the first silicone fluid is added before the second silicone fluid; optionally adding one or more preservatives; and continue mixing for a period of time.

Moreover, the present disclosure describes a method of protecting a surface including applying a composition described herein to the surface to form a coating. In embodiments, the surface includes the surface of a vehicle.

### BRIEF DESCRIPTION OF THE FIGURES

FIG. 1 illustrates that the contact angles for the substrates (vinyl, rubber, and plastic) have all increased after treatment with an exemplary composition (VRP composition) of the present disclosure. An increased contact angle shows that the surface of the substrate has an increased hydrophobicity and an increased ability to repel dirt and water. Thus, the VRP composition enhanced the repellency of the surfaces.

FIG. 2 illustrates the durability of an exemplary VRP composition of the car after 12 car washes. Two different surfaces of a car were treated with the exemplary VRP composition and are shown in FIG. 2, treatment at zero washes and after 12 washes. Color depth stayed darker with the VRP composition than with controls (untreated surface), and the gloss also didn't completely dissipate after the 12 washes.

FIG. 3 illustrates the durability of color depth after treatment with an exemplary VRP composition and after 3 to 12 car washes. The value of the color depth (L) decreased (darkened) in the different areas of the car, such as the top bumper, bottom bumper and side trim, after treatment with the VRP composition. The value of L for the different areas of the car treated with the VRP composition remained lower than the initial value (non-treated color depth) even after successive car washes.

FIG. 4 illustrates the durability of the gloss after treatment with an exemplary VRP composition and after 3 to 12 car washes. The gloss increased in the different areas of the CAR, such as the top bumper, bottom bumper, and side trim, after treatment with the VRP composition. The value of the gloss for the different areas treated with the VRP composition remained higher than the initial value (non-treated) even after successive washes.

FIGS. 5A-5F illustrate gloss and color depth of vinyl (FIG. 5A and FIG. 5F), rubber (FIG. 5B and FIG. 5E), and plastic (FIG. 5C and FIG. 5D) substrates after ultraviolet (UV) light exposure. The substrates were tested for gloss value before application and either treated with an exemplary VRP composition, or left untreated, tested again after 10 minutes, and after being placed under UV lighting for five weeks (24 hours a day and 7 days a week). The treated substrates are compared to corresponding untreated substrates placed under UV lighting for five weeks (24 hours a day, and 7 days a week). Gloss retention by the treated substrates was higher than the untreated substrates even after five weeks under UV lights. In contrast, there was a decrease in gloss value (from the initial value) for the untreated surfaces after being exposed to UV for 5 weeks.

FIGS. 6A and 6B illustrate product surface safety data. An exemplary VRP composition is used on various surfaces such as rubber (6A, left) and a painted panel (6A, right). FIG. 6A shows damage under extreme misuse conditions, i.e. placing a large amount of product on a surface, heating the surface to 85° C., and maintaining this temperature for up to 8 hours. Most products leave some sort of damage under extreme misuse conditions. If used correctly or with slight misuse (leftover lotion from wiping, etc), there is no damage. FIG. 6B shows that the VRP compositions described herein are safe when used appropriately. When applied to a cool surface, there is no damage on vinyl, rubber, plastic, glass, or paint. If applied to a hot surface in a concentrated area and placed back in the hot temperature, there is slight damage to rubber and paint. FIG. 6B shows substrates that had the VRP composition of Example 9 applied to cool surfaces (vinyl (left), rubber (middle), plastic (right)) and then placed in an 85° C. oven for 8 hrs. No visual damage appeared.

FIGS. 7A, 7B, and 7C illustrate contact angle in degrees before application, 10 minutes (mins) after application, and 24 hours (hrs, next day) after application of an exemplary VRP composition on vinyl (FIG. 7A), rubber (FIG. 7B), and plastic (FIG. 7C).

FIGS. 8A, 8B, and 8C illustrate shine based on gloss values measured initially (10 minutes after application) and 24 hrs (next day) after application of the exemplary VRP composition on vinyl (FIG. 8A, 85 degree angle), rubber (FIG. 8B, 65 degree angle), and plastic (FIG. 8C, 85 degree angle) as compared with compositions on the market (Comp C and Comp M) applied on the same materials. FIG. 8D illustrates the shine that the exemplary VRP composition leaves after application. A piece of tape was applied to the center of the vinyl sample, VRP applied to the bottom half of the sample, tape pulled back to show the difference between untreated and treated vinyl surfaces.

FIGS. 9A, 9B, and 9C illustrate color depth measured in Delta L (DL) initially (10 minutes after application) and 24 hrs (next day) after application of the exemplary VRP composition (Armor All 5-10) on vinyl (FIG. 9A), rubber (FIG. 9B) and plastic (FIG. 9C) as compared with compositions on the market (Comp C and Comp M) applied on the same materials.

FIG. 9D illustrates two types of external plastic-shiny plastic on the window trim (left) and a more dull plastic on the bottom trim (right). Tape was used to split each surface into two parts-untreated and treated. Tape was removed to show the benefit of the VRP added shine and color depth to the areas where it was applied.

FIGS. 10A, 10B, and 10C illustrate comparative testing of an exemplary VRP composition applied on rubber (10A), plastic trim (10B), and plastic bumper (10C) compared with compositions on the market (Comp C, Comp M, and Comp O) applied on the same materials. provides higher shine than those compositions on the market applied on the same materials.

FIG. 11 illustrates the VRP composition applied on vinyl, rubber, and plastic imparts a lower Coefficient of Friction as compared to respective untreated materials indicating that VRP can prevent scratches and scuffs.

FIGS. 12A, 12B, and 12C illustrate UV protection of vinyl (FIG. 12A, 85 degree angle), rubber (FIG. 12B, 60 degree angle), and plastic (FIG. 12C, 85 degree angle) by composition based on gloss measurements over a period of 5 weeks. The substrates were tested for gloss value before application (initial) and either treated with an example VRP composition (VRP), a composition on the market (Comp O, Comp C, and Comp M), or left untreated (control), tested again after 10 minutes, and then each consecutive week after being placed under UV lighting for five weeks (24 hours a day and 7 days a week). For each substrate, the gloss retention by the substrates treated with VRP was higher than the untreated substrates (control) at each measurement following treatment. For each substrate, the gloss retention by the substrates treated with VRP was higher than, or equal to, those treated with comparative examples (Comp O, Comp C, and Comp M) after five weeks under UV lights.

### DETAILED DESCRIPTION

The present disclosure describes methods and chemical compositions that effectively restore and protect vinyl, rubber, and plastic (VRP) surfaces. Compositions of the present disclosure may create a “like-new” appearance when applied to VRP surfaces, restoring color depth, and providing a high shine while being non-greasy and dry to the touch. Compositions of the present disclosure may provide protection when applied to VRP surfaces, penetrating pores of the surfaces to provide a barrier of protection from dirt, water, and harmful solar radiation (UVA/UVB). Compositions of the present disclosure may provide heavy-duty and long-lasting protection, for example, for 5 to 20 washes and/or for over a year.

In embodiments, the compositions described herein satisfy consumers' desire for a VRP protectant that is safe and effective on multiple interior and exterior surfaces of vehicles and provides heavy-duty and long-lasting protection against environmental factors such as UV radiation, heat, moisture, and pollutants, enhanced appearance of interior and exterior surfaces, and ease of use requiring minimal effort to achieve non-greasy uniform coverage for a professional, “like-new” appearance.

Compositions described herein may be applied to a VRP surface to form a durable coating that shields the VRP surface from fading, discoloration, and degradation over time, thereby providing heavy-duty and long-lasting protection against environmental factors such as UV radiation, heat, moisture, and pollutants. Long-lasting protection may include wherein the coating remains on the surface for about 5 to 20 washes, about 7 to 15 washes, or about 10 to 13 washes, and/or wherein the coating remains on the surface for 3 to 24 months, 3 to 18 months, 3 to 15 months, 6 to 15 months, or 6 to 12 months.

Compositions described herein provide an enhanced appearance of interior and exterior surfaces, by giving them a deep, rich finish that restores a “like-new” appearance to colors. Compositions can also provide an enhanced and/or high-shine finish, a wet look, and a rich black appearance, for example, to black VRP surfaces. Compositions of the present disclosure provide ease of use and require minimal effort for users to achieve a uniform, streak-free, professional-looking finish to VRP surfaces that leave no buildup of residue, is non-greasy, and is dry to the touch. In embodiments, compositions described herein may be dispensed in a container, for example a pour bottle.

The composition can be used on the interior and exterior surface of vehicles, for example, interior VRP surfaces such as dashboards, door linings, convertible top linings, consoles, and compartments, and exterior VRP surfaces, such as bumpers, rocker panels, weather stripping, vehicle and door trim, truck bed covers, and convertible tops, as well as under the hood components, such as engine covers. Examples of vehicles include automobiles, motorcycles, buses, trains, watercrafts including ships and boats, aircrafts including planes and helicopters, and spacecrafts.

The present disclosure describes VRP restorative and protective compositions including components that interact to create a “like-new” appearance when applied to VRP surfaces, restoring color depth, and providing a high shine while being non-greasy and dry to the touch. The one or more components of the compositions include at least two silicone fluids, one or more mineral oils, one or more rheology modifiers, and one or more solvents. The one or more solvents include at least water and an organic solvent. Optionally, the compositions can include one or more preservatives.

The compositions described herein can include at least two silicone fluids. The silicone fluids include silicone oils having the formula:

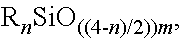

wherein n is 0 to 3, m is 2 or greater, and R is alkyl, alkylene, allyl, aryl, benzyl, phenyl, amine, amide, vinyl, fluoroalkyl, perfluoroalkane, carboxyester, or quaternary alkyl ammonium. In embodiments, the at least two silicone fluids include silicone oils including polydialkylsiloxanes, and optionally wherein the polydialkylsiloxanes include polydimethylsiloxanes.

The at least two silicone fluids include a first silicone fluid and a second silicone fluid. In embodiments, the first silicone fluid has a viscosity of about 100 centistokes (cSt) to 500 cSt, 200 cSt to 450 cSt, or 300 cSt to 400 cSt, and the second silicone fluid has a viscosity of about 10,000 to 15,000 cSt, 11,000 to 14,500 cSt, 11,500 to 14,000 cSt, or 12,000 to 13,000 cSt. For example, the first silicone fluid has a viscosity of about 350 cSt and the second silicone fluid has a viscosity of about 12,500 cSt. The compositions described herein include by total weight of the composition about 1% to 20%, about 2% to 15%, about 3% to 11%, about 4% to 8%, or about 6% of the at least two silicone fluids. The compositions described herein can include about 0.1% to 5% of the first silicone fluid and about 2% to 6% of the second silicone fluid. In embodiments, the first silicone fluid is XIAMETER™ PMX-200 Silicone Fluid 350 cSt, and the second silicone fluid is XIAMETER™ PMX-200 Silicone Fluid 12,500 cSt or ELEMENT14™ PDMS 12.5K.

The compositions described herein can include one or more mineral oils. The one or more mineral oils can include mineral synthetic oil and/or mineral oil obtained from petrochemicals. The compositions described herein include by total weight of the composition about 0.1% to 5%, about 0.2% to 4%, about 0.3% to 3%, about 0.4% to 2%, or about 0.50% of the one or more mineral oils. In embodiments, the one or more mineral oils include SEMTOL® 500 White Mineral Oil.

The compositions described herein can include one or more rheology modifiers, such as acrylate and acrylamide copolymers. Examples of rheology modifiers include other thickeners include polyacrylamides, xanthan gum, carrageenan gum, acacia gum, arabic gum, tragacanth gum, ACRYLIDONE™ (poly(vinyl pyrrolidone/acrylic acid)), VERSAFLEX® One (acrylic-acid based copolymer, and NOVEMER™ EC-1 polymer. The compositions described herein include by total weight of the composition about 0.5% to 5%, about 0.6% to 4%, about 0.7% to 3%, about 0.8% to 2%, or about 0.90% of the one or more rheology modifiers. In embodiments, the one or more rheology modifiers include NOVEMER™ EC-1 polymer.

The compositions described herein can include one or more solvents. The one or more solvents include at least water and an organic solvent. The water solvent can include reverse osmosis (RO) and/or deionized (DI) water. The compositions described herein include by total weight of the composition about 75% to 95%, about 80% to 94%, about 85% to 93%, about 90% to 92%, or about 91.2% of water. In embodiments, the water is deionized water.

The organic solvent can include one or more hydrocarbon solvents, wherein the one or more hydrocarbon solvents include hydrotreated light petroleum distillates, alcohol hydrocarbon solvents, or a combination thereof. Hydrotreated light petroleum distillates may include such as hydrotreated isoparaffins and naphthenics, having a flash point of 210 or 170. The compositions described herein include by total weight of the composition about 0.5% to 5%, about 0.6% to 4%, about 0.8% to 3%, about 1% to 2%, or about 1.25% of the one or more hydrocarbon solvents. In embodiments, the one or more hydrocarbon solvents include LPAR 210 having a flash point of 210 or LPA® 170 having a flash point of 170.

The compositions described herein can further include one or more preservatives. the one or more preservatives include a hydantoin germicide, a carbamate fungicide, benzisothiazolinone (BIT), methylisothiazolinone (MIT), methylchloroisothiazolinone (CMIT), or a combination thereof. In embodiments, the one or more preservatives include TROYGUARD™ BC11 comprising BIT.

The compositions described herein include by total weight of the composition:
about 75% to 95%, about 80% to 94%, about 85% to 93%, about 90% to 92%, or about 91.2% of water;
about 0.5% to 5%, about 0.6% to 4%, about 0.8% to 3%, about 1% to 2%, or about 1.25% of the one or more hydrocarbon solvents;
about 0.5% to 5%, about 0.6% to 4%, about 0.7% to 3%, about 0.8% to 2%, or about 0.90% of the one or more rheology modifiers;
about 1% to 20%, about 2% to 15%, about 3% to 11%, about 4% to 8%, or about 6% of the at least two silicone fluids;
about 0.1% to 5%, about 0.2% to 4%, about 0.3% to 3%, about 0.4% to 2%, or about 0.50% of the one or more mineral oils; and
optionally about 0.01% to 0.5%, about 0.05% to 0.40%, about 0.075% to 0.300%, about 0.090% to 0.200%, or about 0.15% of the one or more preservatives.

In embodiments, the compositions described herein include deionized water, hydrotreated light petroleum distillate, acrylate, and acrylamide copolymers, first polydialkylsiloxane polymer, second polydialkylsiloxane polymer, mineral oil, and benzisothiazolinone. In embodiments, the compositions include silicone fluid of about 350 cSt, silicone fluid of about 12,500 cSt, mineral oil obtained from petrochemicals, acrylate, and acrylamide copolymers, a mixture of hydrotreated isoparaffins and naphthenics, and deionized water; and optionally a preservative including BIT.

In embodiments, the compositions described herein include by total weight of the composition:
about 91.20% water, such as deionized water;
about 1.25% hydrotreated light petroleum distillates, such as a mixture of hydrotreated isoparaffins and naphthenics, and optionally wherein the hydrotreated light petroleum distillate is LPA® 170;
about 0.90% of a rheology modifier including acrylate and acrylamide copolymers, and optionally wherein the rheology modifier is NOVEMER™ EC-1 polymer;
about 0.50% of a first silicone fluid including a polydialkylsiloxane polymer of about 350 cSt, and optionally wherein the first silicone fluid is XIAMETER™ PMX-200 Silicone Fluid 350 cSt;
about 5.50% of a second silicone fluid including a polydialkylsiloxane polymer of about 12,500 cSt, and optionally wherein the silicone fluid is ELEMENT14™ PDMS 12.5K;
about 0.50% mineral oil obtained from petrochemicals, and optionally wherein the mineral oil is SEMTOL® 500; and
about 0.15% of a preservative including benzisothiazolinone (BIT), and optionally wherein the preservative is TROYGUARD™ BC11.

In embodiments, each of the components of the compositions described herein can be a mixture including the main ingredient and some other ingredients. For example, LPAR 210 and LPAR 170 can include hydrotreated light petroleum distillates (about 90 wt % to 100 wt %) as the main ingredient; NOVEMER™ EC-1 polymer can include acrylate and acrylamide copolymer solids as the main ingredient, and mineral oil and polyoxyethylene sorbitan trioleate as the other ingredients; and TROYGUARD™ BC11 can include benzisothiazol-3 (2h)-one (BIT, about 10.1 wt %) as the main ingredient, and 5-chloro-2-methyl-4-isothiazolin-3-one (CMIT, about 0.5 wt %), and 2-methyl-2H-isothiazol-3-one (MIT, 0.16 wt %) as the other ingredients. The other ingredients in each component can also include ingredients that are below reportable levels. The other ingredients can also include small amounts of impurities. The wt % of each ingredient in the mixture of a component is by total weight of the mixture of the component.

The present disclosure also describes methods for preparing the compositions described herein. Methods can include: (i) slowly adding the one or more hydrocarbon solvents to the water that is moving (being mixed) at a slow speed to form a solution; (ii) continue mixing the solution at a slow speed for a period of time, and optionally increasing the speed; (iii) continue mixing and adding the one or more rheology modifiers to the solution and mixing for a period of time; and (iv) continue mixing and adding to the solution of step (iii) in the following order: one or more mineral oils; and one or more silicone fluids, wherein the first silicone fluid is added before the second silicone fluid; and optionally adding one or more preservative; and (v) continue mixing for a period of time, thereby obtaining the composition. In embodiments, the slow speed of steps (i) and (ii) can include mixing at about 100 to 250 revolutions per minute (rpm), and/or wherein a maximum speed for mixing is 450 rpm. In embodiments, the period of time of mixing can include 3 to 30 minutes, 5 to 25 minutes, 5, to 15 minutes, or 5 to 10 minutes.

The methods of preparing the compositions can further include adding one or more preservatives The methods of preparing the composition can further include dispensing the composition into a container. The present disclosure also describes methods of protecting surfaces. The method includes applying a composition described herein to a surface, such as a vinyl, rubber, or plastic surface, and wiping the composition to cover the entire surface. The composition can be dispensed directly onto the surface and distributed evenly on the surface using an applicator. The composition can be dispensed directly onto an applicator and applied to the surface. The applicator can include a sponge, a cloth, a paper towel, a microfiber towel, or a combination thereof.

The surface can be an interior and/or exterior surface of a vehicle, for example, interior VRP surfaces such as dashboards, door linings, convertible top linings, consoles, and compartments, and exterior VRP surfaces, such as bumpers, rocker panels, vehicle, and door trim, truck bed covers, and convertible tops, as well as under the hood components, such as engine covers.

It is the combination of the silicones and the mineral oil in the compositions described herein that gives the VRP surface substrate a barrier of protection from external factors like UV, dirt, and rain. The silicones also give the surface a shiny, “like-new” appearance. The combination of the components can restore and protect VRP surfaces to create a “like-new” appearance when applied, restoring color depth, and providing a high shine while being non-greasy and dry to the touch. Compositions of the present disclosure may form a protective coating that remains on the surface for about 5 to 20 washes, about 7 to 15 washes, or about 10 to 13 washes, and/or wherein the coating remains on the surface for 3 to 24 months, 3 to 18 months, 3 to 15 months, 6 to 15 months, or 6 to 12 months.

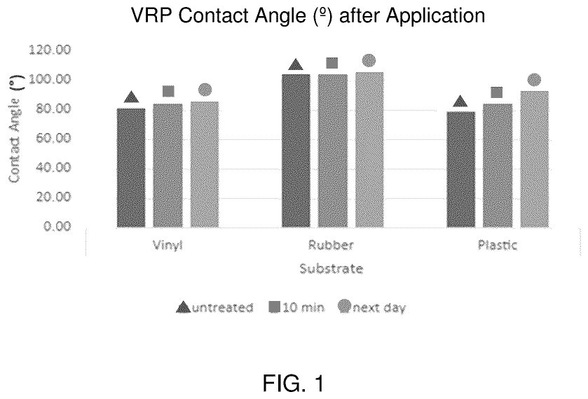

Treatment of surfaces with the compositions of the present disclosure increased the contact angles, which is the angle between a liquid droplet and a solid surface where they meet (FIG. 1). Increased contact angles indicate that treatments with the compositions of the present disclosure enhanced the hydrophobicity of the surfaces. For example, 24 hours after application, there is an increase in contact angle: contact angles can be about 90° or greater on vinyl surfaces, an increase of about 1-5%; contact angles can be about 100° or greater on rubber surfaces, an increase of about 15-25%; contact angles can be greater than about 80° on plastic trim, an increase of about 8-15% after application; contact angles can be greater than about 80° on ABS Black surfaces, an increase of about 5-10% after application; and contact angles can be greater than about 80° on PVC/Acrylic Gray, increase of about 0-5% after application. Hydrophobicity is important for repellency and protecting surfaces from damage including water damage, stains, and dirt. In general, if the contact angle of the liquid is close to or larger than 80°, then the surface is hydrophobic.

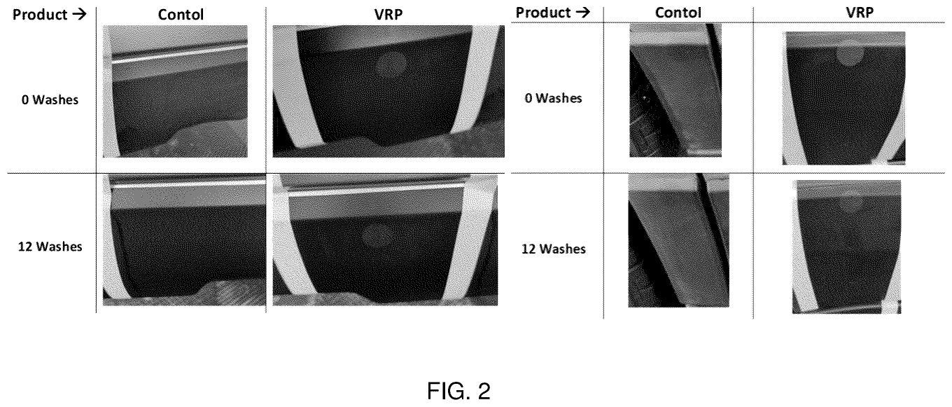

The compositions of the present disclosure provided durable protection of the surfaces (FIG. 2). As an example, even after 12 washes, the color depth of the surface treated with the composition of the present disclosure remained darker than the untreated surface (control). Color Depth (L) indicates the lightness (L value) of a surface, where the higher the L value, the lighter the color, and the closer to 0 the L value, the darker, or more black the surface. Moreover, the gloss of the surface treated with the composition of the present disclosure did not completely dissipate even after 12 washes. The compositions of the present disclosure remained on the surfaces and were not washed off with successive car washes indicating that the compositions can provide long-lasting protection.

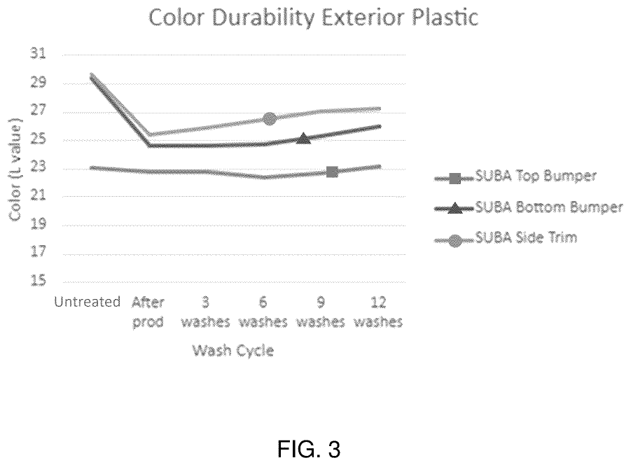

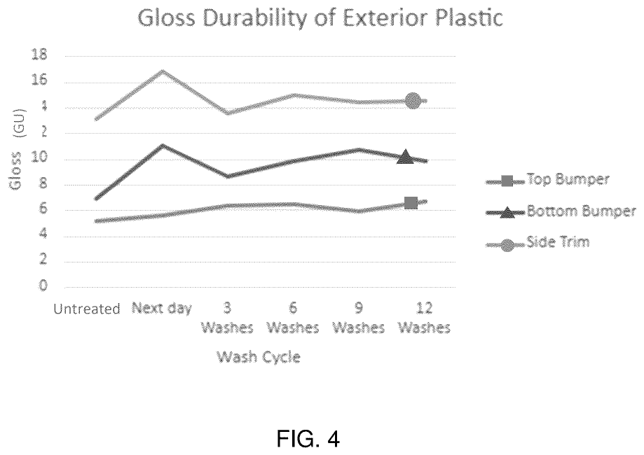

The compositions of the present disclosure provided durable color depth and gloss to the surfaces (FIGS. 3 and 4). Once the composition of the present disclosure was applied to a surface, the color of the surface darkens, and even after successive car washes, the value of the color depth (L value) remains lower than the initial value (non-treated). A lower color depth (L value) indicates a darker color. As an example, 24 hours after application, there is a decrease in the L value (bit depth): the L value of vinyl can be about 22, an increase of about 8-13% in darkness; the L value for rubber can be about 23, an increase of about 15-20% in darkness; the L value for plastic trim can be about 27, an increase in darkness of about 10-20%; the L value of ABS Black can be about 16 with an increase in darkness of about 40-50%; and the L value of PVC/Acrylic Gray can be about 53 with an increase in darkness of about 1-3%.

Similarly, after the application of the composition, the gloss of the surface increased, and the value of the gloss remained higher than the initial value (non-treated) even after successive washes. As an example, 24 hours after application, there is an increase in gloss value (GU): the GU value of vinyl can be about 5 or greater, an increase of about 115-125%; the GU value of rubber can be about 9.0 or greater, an increase of about 0 to 1%; the GU value of plastic trim can be about 15 or greater, an increase of about 18-22%; the GU value of ABS black can be about 15, an increase of about 0-1%; and the GU value of PVC/Acrylic Gray can be about 1.0 or greater, an increase of about 20-30%.

The durable color depth and gloss indicated that the compositions of the present disclosure remained on the surfaces and were not washed off with successive car washes.

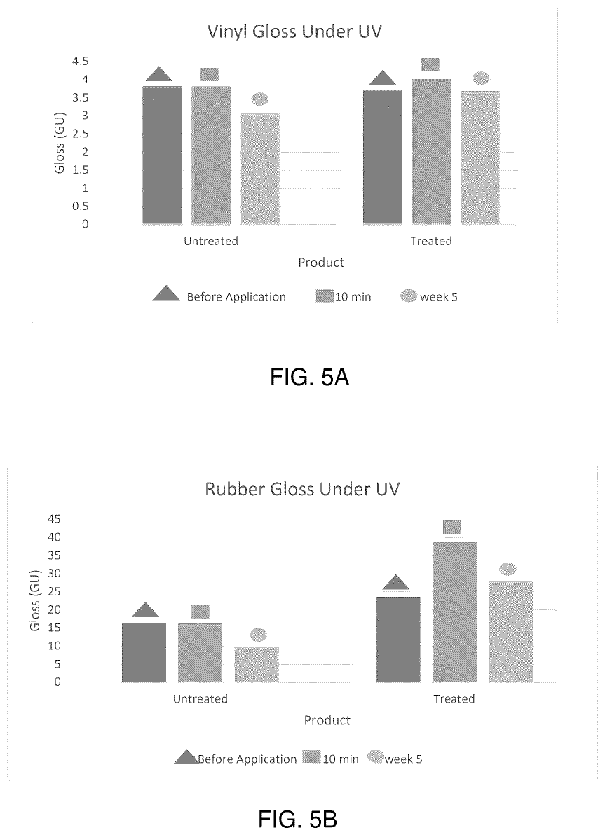

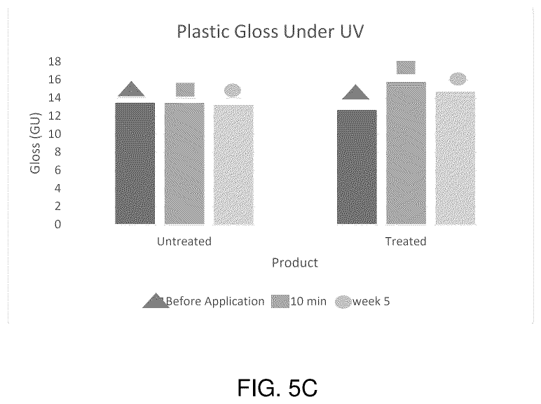

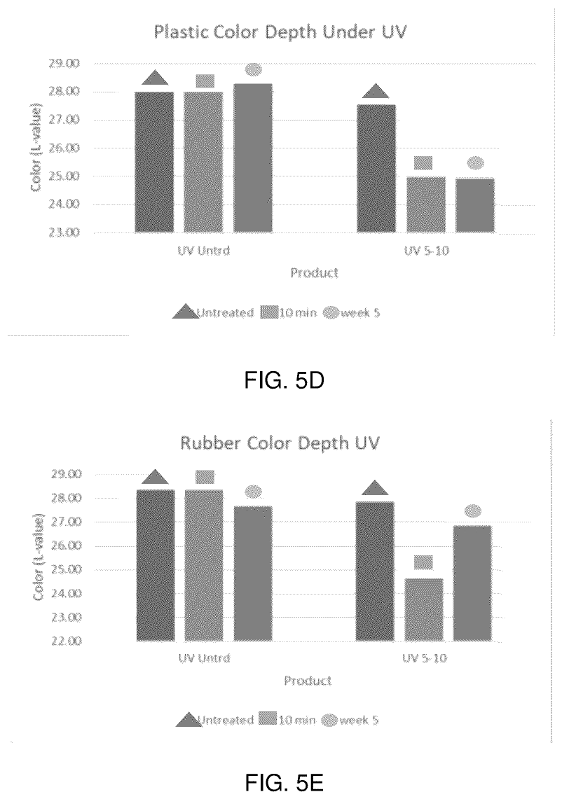

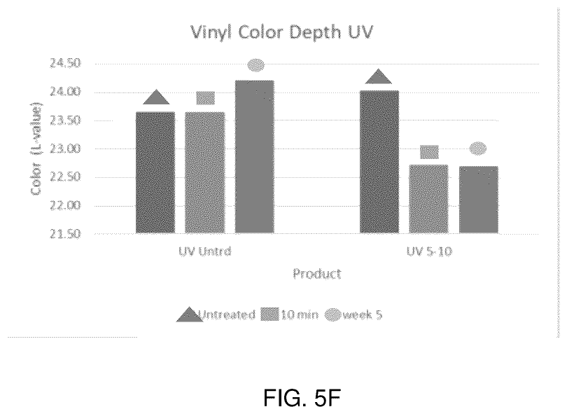

The compositions of the present disclosure provided protection even under harsh conditions (FIGS. 5A-5C), such as constant exposure to UV light (24 hours a day and 7 days a week). As an example, vinyl, plastic, and rubber surfaces treated with the composition of the present disclosure retained their gloss values even after five weeks of exposure to UV light for 24 hours a day and 7 days a week. In contrast, there was a decrease in gloss value (from the initial value) for the untreated surfaces after being exposed to UV light for 5 weeks. The compositions of the present disclosure protected the surfaces even under harsh conditions such as exposure to UV light. Other harsh conditions include exposure to high temperature and/or high humidity.

The compositions of the present disclosure also help prevent surface scratches and scuffs. When there is a large amount of force needed to get one object to slide across another object then there is more chance of a scratch or scuff to occur. When the coefficient of friction decreases, objects have the opportunity to slide or glide off a surface rather than catch on the surface causing a scratch. The British Pendulum Test which measures the Pendulum Test Value (PTV) can be used to provide the Coefficient of friction (Coef). The smaller the PTV the lower the Coef indicating there is less force resisting the motion. The compositions of the present disclosure provides a lower PTV value. As an example, after application, there is a decrease in PTV value: the PTV of vinyl decreased about 35% or greater, 35-45%, or 35-40%; the PTV of rubber decreased about 25% or greater, 25-35%, or 25-30%; and the PTV of plastic decreased about 40% or greater, 40-60%, 45-55%, or 50-55%.

In embodiments, the compositions described herein can be used to treat various surfaces including plastic and rubber. The term plastic includes hard plastic and vinyl, which is soft and flexible. Vinyl surfaces may include soft flexible plastics such as those found on dashboards, consoles, compartments, door linings, steering wheels, gear shift nobs, and convertible top linings. Plastic surfaces may include hard plastics such as bumpers, rocker panels, weather stripping, vehicle and door trim, truck bed covers, and convertible tops, as well as under the hood components, such as engine covers. Rubber surfaces may include door seals.

The terms “composition(s)” and “formulation(s)” are used interchangeably to refer to the compositions described herein.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the composition, such as increased hydrophobicity for protecting a surface.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

It is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are exemplary embodiments:

1. A composition including:
at least two silicone fluids: a first silicone fluid and a second silicone fluid;
one or more mineral oils;
one or more rheology modifiers;
one or more hydrocarbon solvents; and water; and
optionally one or more preservatives.

2. The composition of embodiment 1, wherein the composition includes by total weight of the composition:
about 1% to 20% of the at least two silicone fluids;
about 0.1% to 5% of the one or more mineral oils;
about 0.5% to 5% of the one or more rheology modifiers;
about 0.5% to 5% of the one or more hydrocarbon solvents; and
about 75% to 95% of water; and
optionally about 0.01% to 0.5% of the one or more preservatives.

3. The composition of embodiment 1 or 2, wherein the composition includes by total weight of the composition: about at least 0.1% to 5% of the first silicone fluid and about at least 2% to 6% of the second silicone fluid.

4. The composition of any one of embodiments 1-3, wherein the first silicone fluid has a viscosity of about 100 centistokes (cSt) to 500 cSt, 200 cSt to 450 cSt, or 300 cSt to 400 cSt, and the second silicone fluid has a viscosity of about 10,000 to 15,000 cSt, 11,000 to 14,500 cSt, 11,500 to 14,000 cSt, or 12,000 to 13,000 cSt.

5. The composition of any one of embodiments 1-4, wherein the first silicone fluid has a viscosity of about 350 cSt and the second silicone fluid has a viscosity of about 12,500 cSt.

6. The composition of any one of embodiments 1-5, wherein the silicone fluids include silicone oils having the formula:

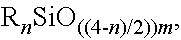

wherein:
n is 0 to 3;
m is 2 or greater; and
R is alkyl, alkylene, allyl, aryl, benzyl, phenyl, amine, amide, vinyl, fluoroalkyl, perfluoroalkane, carboxyester, or quaternary alkyl ammonium.

7. The composition of any one of embodiments 1-6, wherein the silicone fluids include silicone oils including polydialkylsiloxanes; and optionally, wherein the polydialkylsiloxanes include polydimethylsiloxanes.

8. The composition of any one of embodiments 1-7, wherein the one or more mineral oils include mineral synthetic oil and/or mineral oil obtained from petrochemicals.

9. The composition of any one of embodiments 1-8, wherein the one or more rheology modifiers include acrylate and acrylamide copolymers.

10. The composition of any one of embodiments 1-9, wherein the one or more hydrocarbon solvents include hydrotreated light petroleum distillates, alcohol hydrocarbon solvents, or a combination thereof.

11. The composition of any one of embodiments 1-10, wherein the one or more hydrocarbon solvents include hydrotreated isoparaffins and naphthenics.

12. The composition of any one of embodiments 1-11, wherein the one or more preservatives include a hydantoin germicide, a carbamate fungicide, benzisothiazolinone (BIT), methylisothiazolinone (MIT), or methylchloroisothiazolinone (CMIT), or a combination thereof.

13. The composition of any one of embodiments 1-12, wherein the one or more preservatives include a combination of BIT, MIT, and CMIT.

14. The composition of any one of embodiments 1-13, wherein the composition includes silicone fluid of about 350 cSt, silicone fluid of about 12,500 cSt, mineral oil obtained from petrochemicals, acrylate and acrylamide copolymers, a mixture of hydrotreated isoparaffins and naphthenics, and water; and optionally a preservative including BIT, MIT, and CMIT.

15. A method of preparing the composition of any one of embodiments 1-14, wherein the method includes:
(i) slowly adding the one or more hydrocarbon solvents to the water that is moving at a slow speed to form a solution;
(ii) mixing the solution for a period of time at the slow speed, and optionally increasing the speed;
(iii) continue mixing and adding the one or more rheology modifiers to the solution and mixing for a period of time; and
(iv) continue mixing and adding to the solution of step (iii) in the following order: (i) one or more mineral oils; and (ii) one or more silicone fluids, wherein the first silicone fluid is added before the second fluid; and optionally adding the one or more preservatives; and
(v) continue mixing for a period of time, thereby obtaining the composition of any one of embodiments 1-14.

16. The method of embodiment 15, wherein a period of time is about 3 to 30 minutes, 5 to 25 minutes, 5, to 15 minutes, or 5 to 10 minutes.

17. The method of embodiment 15 or 16, wherein slow speed for mixing is about 100 to 250 revolutions per minute (rpm), and/or wherein maximum speed for mixing is about 450 rpm.

18. The method of any one of embodiments 15-17, wherein the method further includes dispensing the composition in a container.

19. A method of protecting a surface, wherein the method includes applying the composition of any one of embodiments 1-14 to a surface to form a coating, and wherein the surface is rubber or plastic.

20. The method of embodiment 19, wherein the plastic is vinyl.

21. The method of embodiment 19 or 20, wherein the surface is a surface of a vehicle.

22. The method of any one of embodiments 19-21, wherein the surface is the surface of a dashboard, convertible tops, door lining, bumper, truck bed covers, rocker panels, weatherstripping, or door trim.

23. The method of any one of embodiments 19-22, wherein the coating remains on the surface for about 5 to 20 washes, about 7 to 15 washes, or about 10 to 13 washes.

24. The method of any one of embodiments 19-23, wherein the coating remains on the surface for 3 to 24 months, 3 to 18 months, 3 to 15 months, 6 to 15 months, or 6 to 12 months.

25. The method of any one of embodiments 19-24, wherein the surface is hydrophobic.

26. The method of any one of embodiments 19-25, wherein the surface has a higher gloss value and/or lower color depth value than a surface that has not been applied with the composition.

### EXAMPLES

Representative embodiments of the present disclosure will now be described with reference to the following examples that illustrate the principles and practice of the present disclosure.

VRP protecting and restoring compositions were prepared as shown in the Examples below.

### Example 1

TABLE 1

| | | Component |
|---|---|---|
| Component | Function | Quantity |
| DI Water | Diluent | 91.200 |
| LPA ® 170 | Solvent | 1.250 |
| NOVEMER ™ EC-1 polymer | Rheology | 0.900 |
| | Modifier | |
| XIAMETER PMX-200 | Silicone | 0.500 |
| Silicone Fluid 350 cSt | | |
| ELEMENT14 ™ PDMS 12.5K | Silicone | 5.500 |
| SEMTOL ® 500 | Mineral Oil | 0.500 |
| TROYGUARD ™ BC11 | Preservative | 0.150 |
| Total | | 100.00 |

The VRP composition of Example 1 was prepared by: (i) mixing the DI water at a speed of about 200 revolutions per minute (rpm) and slowly adding the LPA® 170; (ii) adjusting the speed to about 450 rpm and mixing for 5 minutes; (iii) continuing mixing the solution at 450 rpm, and adding the NOVEMER™ EC-1 polymer; (iv) mixing the solution for 15 minutes, and if necessary adjust the speed (maximum speed is 450 rpm); (v) adding in sequential order: SEMTOL® 500, XIAMETER PMX-200 Silicone Fluid 350 cSt, ELEMENT14™ PDMS 12.5K, and TROYGUARD™ BC11; and (vi) mixing the solution for 15 minutes and if necessary adjust the speed (maximum speed is 450 rpm).

### Example 2

TABLE 2

| | | Component |
|---|---|---|
| Component | Function | Quantity |
| Water | Diluent | 75.00-95.00 |
| LPA ® 170 | Solvent | 0.50-5.00 |
| NOVEMER ™ EC-1 polymer | Rheology | 0.50-5.00 |
| | Modifier | |
| XIAMETER PMX-200 Silicone | Silicone | 0.10-5.00 |
| Fluid 350 cSt | | |
| ELEMENT14 ™ PDMS 12.5K | Silicone | 0.9-15 |
| SEMTOL ® 500 | Mineral Oil | 0.10-5.00 |
| TROYGUARD ™ BC11 | Preservative | 0.01-0.50 |
| Total | | 100.00 |

The VRP composition of Example 2 was prepared as described in Example 1.

### Example 3

TABLE 3

| | | Component |
|---|---|---|
| Component | Function | Quantity |
| Water | Diluent | 75.00-95.00 |
| hydrotreated isoparaffins | Solvent | 0.50-5.00 |
| and naphthenics | | |
| acrylate and acrylamide | Rheology | 0.50-5.00 |
| copolymers | Modifier | |
| polydialkylsiloxane | Silicone | 0.10-5.00 |
| polymer 100 to 500 | | |
| cSt (optionally 350 cSt) | | |
| polydialkylsiloxane | Silicone | 0.9-15 |
| polymer 1000 to 1500 | | |
| cSt (optionally 12,500 cSt) | | |
| Mineral Oil | Mineral Oil | 0.10-5.00 |
| BIT | Preservative | 0.01-0.50 |
| Total | | 100.00 |

The VRP composition of Example 3 was prepared by: (i) mixing the water at a speed of about 200 revolutions per minute (rpm) and slowly adding the hydrotreated isoparaffins and naphthenics; (ii) adjusting the speed to about 450 rpm and mixing for 5 minutes; (iii) continuing mixing the solution at 450 rpm, and adding the acrylate and acrylamide copolymers; (iv) mixing the solution for 15 minutes, and if necessary adjust the speed (maximum speed is 450 rpm); (v) adding in sequential order: mineral oil, polydialkylsiloxane polymer 100 to 500 cSt (optionally 350 cSt), polydialkylsiloxane polymer 1000 to 1500 cSt (optionally 12,500 cSt), and BIT; and (vi) mixing the solution for 15 minutes and if necessary adjust the speed (maximum speed is 450 rpm).

### Example 4

This study was performed to determine whether the compositions of the present disclosure can increase the contact angle of various surfaces.

The VRP composition of Example 1 was applied to vinyl, rubber, and plastic substrates with an applicator. After waiting 10 minutes and 24 hours, the contact angles were measured by taking Contact Angle (Hydrophobicity) readings using a KRUSS Mobile Surface Analyzer (MSA). Briefly, water was dropped on the treated substrates and the contact angles were measured by the MSA. A higher degree) (° indicates a more hydrophobic surface. The contact angle results are averages from 6 readings from different points on the surface. The same method was used to measure the contact angle of the corresponding untreated substrates (control). The results are shown in Table 4 and FIG. 1. The results indicate that the contact angles for the substrates (vinyl, rubber, and plastic) have all increased after treatment with the VRP composition of Example 1.

TABLE 4
Contact Angles (°)

| | Vinyl | Rubber | Plastic |
|---|---|---|---|
| untreated | 81.30 | 104.53 | 78.71 |
| 10 min | 84.04 | 104.14 | 83.97 |
| next day | 85.97 | 105.62 | 92.83 |

### Example 5

This study was performed to determine the durability of the compositions of the present disclosure.

The VRP composition of Example 1 was applied to two different areas of a car with an applicator. After waiting 2 days, the car was washed successively 12 times. Each wash was a touchless wash performed with a foam cannon. The touchless wash method was used to ensure results were not biased by allowing physical agitation of the surface. FIG. 2 shows the durability of the composition after 12 snow foam car washes. The surfaces treated with the VRP composition of Example 1 (VRP) were compared to the untreated surfaces (control) before the first car wash and after every 3 car washes and up to 12 car washes. The circle in the middle of the treated (VRP) surface is also an untreated surface as a sticker was added to prevent the composition from being applied. The sticker was then removed and the surface was washed. After 12 washes, the contrast between the sticker surface (untreated) and the surrounding treated surface can be seen.

Color depth of the areas treated with the VRP composition of Example 1 remained darker than the color depth of the controls. The gloss of the treated areas also didn't completely dissipate after the 12 washes.

### Example 6

This study was performed to determine the durability of the color depth of the surface after treatment with compositions of the present disclosure.

The VRP composition of Example 1 was applied to the top bumper, the bottom bumper, and the side trim of the car with an applicator. After waiting 2 days, the car was washed successively 12 times. Each wash was a touchless wash performed with a foam cannon. The color depth (L) was determined with a reflectance spectrophotometer, which shines a beam of light and measures the amount of light reflected from different wavelengths of the visible spectrum. The color depth (L) was measured initially (prior to treatment), 2 days after treatment, and after 3, 6, 9, and 12 car washes. The L value (lightness) is a metric for how much a composition darkens a surface. The L value is determined by calculating the difference in spectrophotometer readings before and after application. A lower value shows a darker surface, and a higher value shows a lighter surface.

FIG. 3 shows the durability of the color depth of the different areas of the car initially (before treatment), after treatment with the VRP composition of Example 1 (after), and after 3, 6, 9, and 12 car washes. The value of the color depth (L) decreased in the different areas of the car, such as the top bumper, bottom bumper and side trim, after treatment with the VRP composition. A lower color depth indicates a darker color. The value of L for the different areas of the car treated with the VRP composition of Example 1 remained lower than the initial value (non-treated) even after successive car washes.

### Example 7

This study was performed to determine the durability of gloss of the surface after treatment with compositions of the present disclosure.

The VRP composition of Example 1 was applied to the top bumper, the bottom bumper, and the side trim of the car with an applicator. After waiting 2 days, the car was washed successively 12 times. Each wash was a touchless wash performed with a foam cannon. Gloss was determined with a gloss meter which shines a beam of light at a constant intensity and angle onto a surface and measures the amount of reflected light at an equal but opposite angle. Vinyl and plastic were measured at an angle of 85° and rubber was measured at an angle of 60°. Measurements were taken at several different areas of the surface and averaged together. Higher gloss units (GU) show a more reflective surface. The Gloss was measured initially (prior to treatment), the next day (after treatment), and after 3 to 12 car washes. An air dryer was used to dry the surfaces after each wash. Measurements were taken after every third wash as soon as the surface was dry.

FIG. 4 illustrates the durability of the gloss after treatment (the next day) with the VRP composition of Example 1 and after 3 to 12 car washes. The gloss increased in the different areas of the CAR, such as the top bumper, bottom bumper, and side trim, after treatment with the composition of Example 1. The value of the gloss for the different areas treated with the VRP composition of Example 1 remained higher than the initial value (non-treated) even after successive washes.

### Example 8

This study was performed to determine the durability of gloss of the surface after treatment with compositions of the present disclosure under harsh conditions, for example, under constant UV exposure.

The VRP composition of Example 1 was applied to vinyl, rubber, and plastic substrates. After application, the treated substrates were exposed to UV light for 5 weeks (24 hours a day and 7 days a week), and gloss was measured as described in Example 7. For comparison, gloss was also measured for untreated substrates that were also exposed to UV light for 5 weeks. The gloss values are summarized in Table 5A and FIGS. 5A-5C and color depth values are summarized in Table 5B and FIGS. 5D-5F.

FIGS. 5A, FIG. 5B, FIG. 5C, and Table 5A show the gloss of vinyl (FIG. 5A), rubber (FIG. 5B), and plastic (FIG. 5C) substrates after ultraviolet (UV) light exposure. The substrates were tested for gloss value before application and either treated with the VRP composition of Example 1, or left untreated, tested again after 10 minutes, and after being placed under UV lighting for five weeks (24 hours a day and 7 days a week). The treated substrates are compared to corresponding untreated substrates placed under UV lighting for five weeks (24 hours a day, and 7 days a week). Gloss retention by the treated substrates was higher than the untreated substrates even after five weeks under UV lights. In contrast, there was a decrease in gloss value (from the initial value) for the untreated surfaces after being exposed to UV for 5 weeks.

TABLE 5A
Gloss (GU) Under UV

| | | Untreated | 10 min | Week 5 |
|---|---|---|---|---|
| Vinyl | Untreated | 3.8 | 3.8 | 3.1 |
| | Treated | 3.7 | 4.0 | 3.7 |
| Rubber | Untreated | 16.3 | 16.3 | 9.8 |
| | Treated | 23.6 | 38.7 | 27.9 |
| Plastic | Untreated | 13.4 | 13.4 | 13.2 |
| | Treated | 12.6 | 15.7 | 14.7 |

FIGS. 5D, FIG. 5E, FIG. 5F, and Table 5B show the color depth of vinyl (FIG. 5A), rubber (FIG. 5B), and plastic (FIG. 5C) substrates after ultraviolet (UV) light exposure. The substrates were tested for color depth before application and either treated with the VRP composition of Example 1, or left untreated, tested again after 10 minutes, and after being placed under UV lighting for five weeks (24 hours a day and 7 days a week). The treated substrates are compared to corresponding untreated substrates placed under UV lighting for five weeks (24 hours a day, and 7 days a week). After application of the VRP composition of Example 1, the color value lowered so the substrate got darker which is good because a decrease in L-value corresponds to a darker color. After five weeks the VRP composition continued to show a deeper color after UV when compared to the untreated surface after UV. The untreated substrate saw an increase in L-value under UV which indicated the color is lightening without the protection of the VRP composition.

TABLE 5B
Color Depth Under UV

| | | Untreated | 10 min | Week 5 |
|---|---|---|---|---|
| Vinyl | Untreated | 23.65 | 23.65 | 24.20 |
| | Treated | 24.02 | 22.72 | 22.69 |
| Rubber | Untreated | 28.34 | 28.34 | 27.65 |
| | Treated | 27.83 | 24.64 | 26.82 |
| Plastic | Untreated | 27.98 | 27.98 | 28.28 |
| | Treated | 27.54 | 24.95 | 24.90 |

### Example 9

TABLE 6

| | | Component |
|---|---|---|
| Component | Function | Quantity |
| DI Water | Diluent | 91.200 |
| LPA ® 210 | Solvent | 1.250 |
| NOVEMER ™ EC-1 polymer | Rheology | 0.900 |
| | Modifier | |
| XIAMETER PMX-200 | Silicone | 0.500 |
| Silicone Fluid 350 cSt | | |
| ELEMENT14 ™ PDMS 12.5K | Silicone | 5.500 |
| SEMTOL ® 500 | Mineral Oil | 0.500 |
| TROYGUARD ™ BC11 | Preservative | 0.150 |
| Total | | 100.00 |

The VRP composition of Example 9 was prepared by: (i) adding the DI Water to a mixing tank, the water can be added to cover one or more impellers of an agitator, and agitation (mixing) throughout the preparation process should be enough to impart significant fluid movement, without excessive air entrainment; (ii) adding the LPAR 210 and mixing for about 5 minutes, or until homogeneous; (iii) adding the NOVEMER™ EC-1 and mixing for about 10 minutes, or until homogeneous, adjusting the agitation speed as needed; (iv) adding the mineral oil and silicone oils (Silicone 12,500 cSt and Silicone 350 cSt) and mixing for about 20 minutes, or until homogeneous, adjusting agitation speed as needed; (v) adding TROYGUARD™ BC11 and mixing for about 5 minutes, or until homogenous, adjusting agitation speed as needed; and (vi) mixing for an additional 30 minutes.

Formula stability for the VRP composition of Example 9 is shown in Table 7. The composition passed a room temperature (RT) stability test that included keeping the composition at RT for 12 weeks, three cycles of freeze/thaw stability testing that included freezing the samples in a freezer overnight, taking them out to thaw, and repeating two more times, and stability at elevated temperatures (45° C. and 55° C.). The samples were checked to see if any of the conditions cause any changes to the composition, or if they causes the formula to separate/settle. In embodiments, the composition was shaken well before use.

TABLE 7
Stability VRP 5-10-4

| Temp | RT | | | 45 C. | | | 55 C. | | | FR | | |
|---|---|---|---|---|---|---|---|---|---|---|---|---|
| Week | pH | Density | Viscosity | pH | Density | Viscosity | pH | Density | Viscosity | pH | Density | Viscosity |
| Wk 1 | | | | 7 | 1.00 | 8120 | 7 | 1.00 | 7780 | 7 | 1.00 | 7420 |
| Wk 2 | | | | 7 | 1.00 | 8480 | 7 | 1.00 | 9280 | 7 | 0.97 | 7800 |
| Wk 3 | 7 | 1.00 | 7480 | 7 | 1.00 | 7900 | 7 | 1.00 | 8380 | 7 | 0.97 | 6740 |
| Wk 4 | 7 | 1.00 | 7740 | 7 | 1.00 | 8180 | 7 | 1.00 | 8480 | 7 | 0.97 | 7300 |
| Wk 6 | 7 | 1.01 | 8040 | 7 | 1.00 | 8600 | 7 | 1.00 | 9100 | 7 | 0.96 | 8320 |
| Wk 8 | 7 | 1.00 | 7900 | 7 | 0.99 | 8940 | 7 | 1.00 | 8120 | 7 | 0.96 | 7800 |
| Wk 10 | 7 | 1.00 | 8180 | 7 | 1.00 | 9180 | 7 | 1.00 | 9260 | 7 | 0.97 | 8320 |

The VRP composition of Example 9 also passed 3 rounds of microchallenge (fungal and bacterial) testing for reduction of fungal and bacterial organisms.

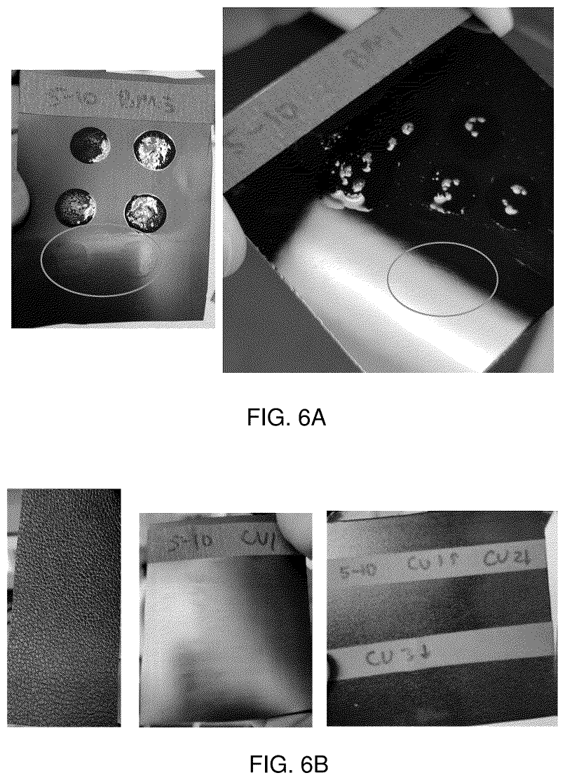

Surface safety testing outcomes for the VRP composition of Example 9 are given in Table 8, and shown in FIGS. 6A and 6B.

TABLE 8

| | | Accidental | |
|---|---|---|---|
| Substrate | Correct Use | Misuse | Blatant Misuse |
| Vinyl-Black | No Damage | No Damage | IPA Removed |
| Rubber | No Damage | No Damage | Light Damage |
| Plastic | No Damage | No Damage | No Damage |
| Paint-Black | No Damage | No Damage | Light Damage |
| Glass | No Damage | No Damage | No Damage |

FIGS. 6A and 6B illustrate product surface safety data. The VRP composition of Example 9 is used on various surfaces such as rubber (6A, left) and a painted panel (6A, right). FIG. 6A shows damage under extreme misuse conditions, i.e. placing a large amount of product on a surface, heating the surface to 85° C., and maintaining this temperature for up to 8 hours. Most products leave some sort of damage under extreme misuse conditions. If used correctly or with slight misuse (leftover lotion from wiping, etc), there is no damage. FIG. 6B shows that the VRP compositions described herein are safe when used appropriately. When applied to a cool surface, there is no damage on vinyl, rubber, plastic, glass, or paint. If applied to a hot surface in a concentrated area and placed back in the hot temperature, there is slight damage to rubber and paint. FIG. 6B shows substrates that had the VRP composition of Example 9 applied to cool surfaces (vinyl (left), rubber (middle), plastic (right)) and then placed in an 85° C. oven for 8 hrs. No visual damage appeared.

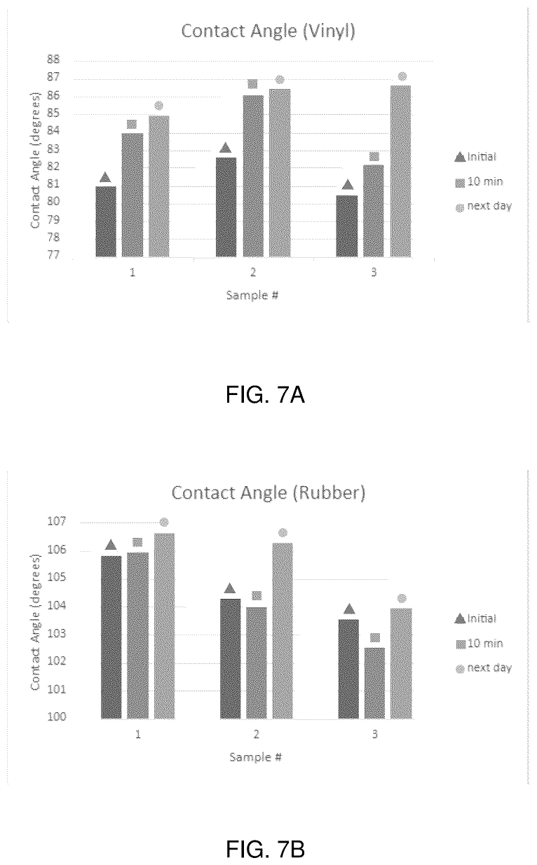

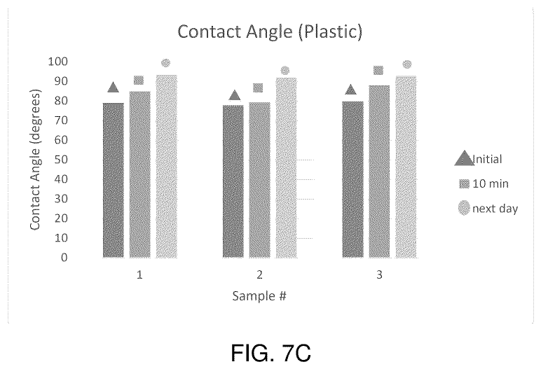

The VRP composition of Example 9 was shown to repels dirt and water. Contact angle testing for vinyl is shown in FIG. 7A, rubber is shown in FIG. 7B, and rubber is shown in FIG. 7C. Contact angle is shown in degrees before application, 10 minutes (mins) after application, and 24 hours (hrs, next day) after application of the VRP composition of Example 9. The results indicate that the contact angles for the substrates (vinyl, rubber, and plastic) have all increased after treatment with the VRP composition of Example 9.

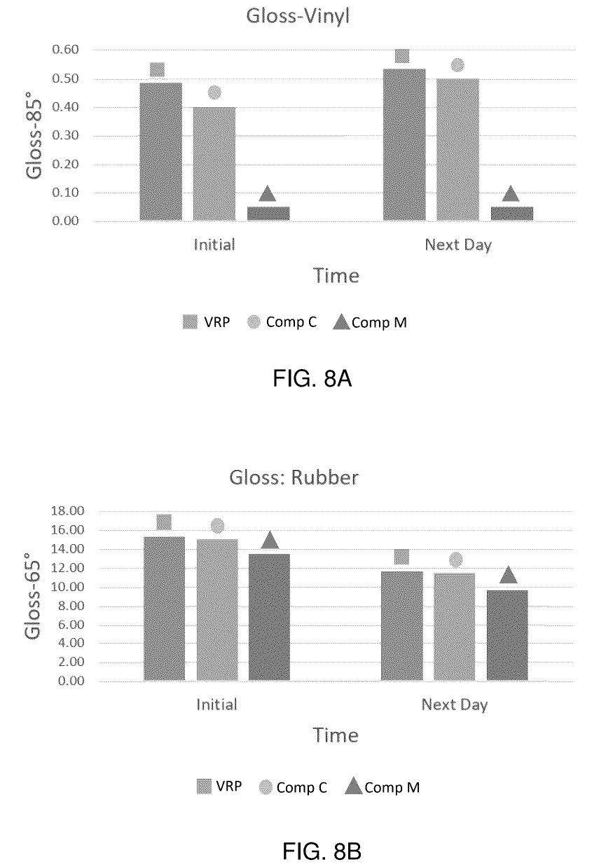

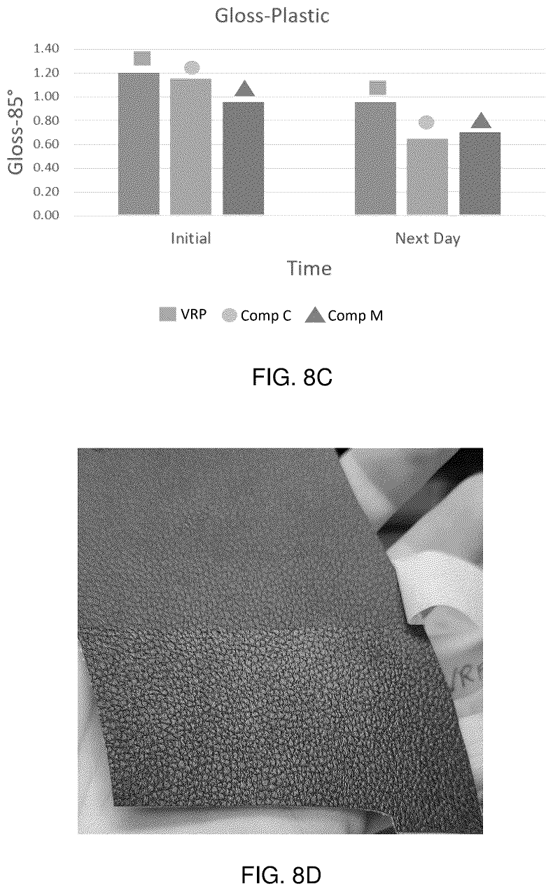

The VRP composition of Example 9 was shown to have high shine. FIGS. 8A, 8B, and 8C show shine based on gloss values measured initially (10 minutes after application) and 24 hrs (next day) after application of the VRP composition of Example 9 on vinyl (FIG. 8A, 85 degree angle), rubber (FIG. 8B, 65 degree angle), and plastic (FIG. 8C, 85 degree angle) as compared with compositions on the market (Comp C and Comp M) applied on the same materials. FIG. 8D illustrates the shine that the exemplary VRP composition leaves after application. A piece of tape was applied to the center of the vinyl sample, VRP applied to the bottom half of the sample, tape pulled back to show the difference between untreated and treated vinyl surfaces. The VRP gloss values are higher than competitors at the initial point (10 minutes after application) and also the next day. Gloss evaluation with the BYK micro-TRI-gloss meter. Initial reading is the value 10 minutes after the product was applied and next day is value taken from 18-24 hrs from the initial reading.

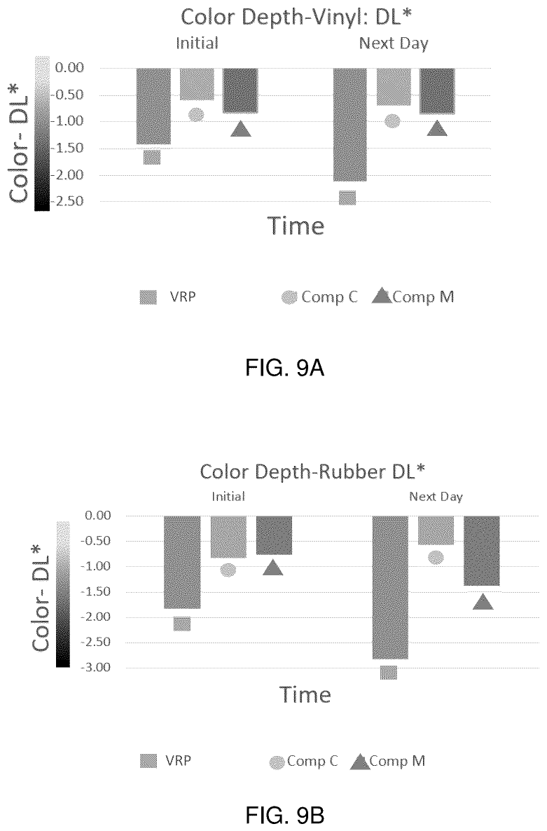

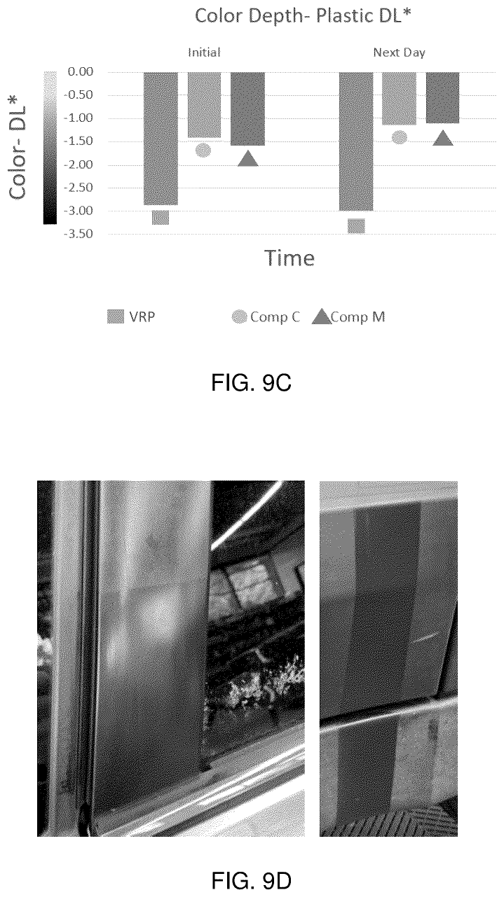

The VRP composition of Example 9 was shown to restore interior and Exterior Vinyl, Rubber, and Plastic. FIGS. 9A, 9B, and 9C illustrate color depth measured in Delta L (DL) initially (10 minutes after application) and 24 hrs (next day) after application of the VRP composition of Example 9 on vinyl (FIG. 9A), rubber (FIG. 9B) and plastic (FIG. 9C) as compared with compositions on the market (Comp C and Comp M) applied on the same materials. Color Depth (L) indicates the lightness (L value) of a surface, where the higher the L value, the lighter the color, and the closer to 0 the L value, the darker, or more black the surface. Delta L (DL) indicates the difference in lightness between two colors, typically a sample and a standard, where a positive DL value indicates that the sample is lighter than the standard, while a negative value indicates the sample is darker than the standard. FIGS. 9A, 9B, and 9C, show the difference in lightness of the surface before application of the indicated composition and the same surface 10 minutes after application of the indicated composition (initial) and the next day after application of the indicated composition (next day).

As car surfaces age, specifically vinyl, rubber and plastic areas, the oils originally in the surface come out and the appearance looks weathered. By adding products containing silicone oils and mineral oils, the consumer adds the oils back into the surfaces, rehydrating those areas and making them look renewed. Testing was done using an X-rite colorimeter and recording the L values on vinyl, rubber, and plastic substrates. As the product is applied to a substrate, the preferred L value is a value smaller than the L value of the untreated surface because then the product has increased the color depth make it look restored. FIG. 9D illustrates two types of external plastic-shiny plastic on the window trim (left) and a more dull plastic on the bottom trim (right). Tape was used to split each surface into two parts-untreated and treated. Tape was removed to show the benefit of the VRP added shine and color depth to the areas where it was applied.

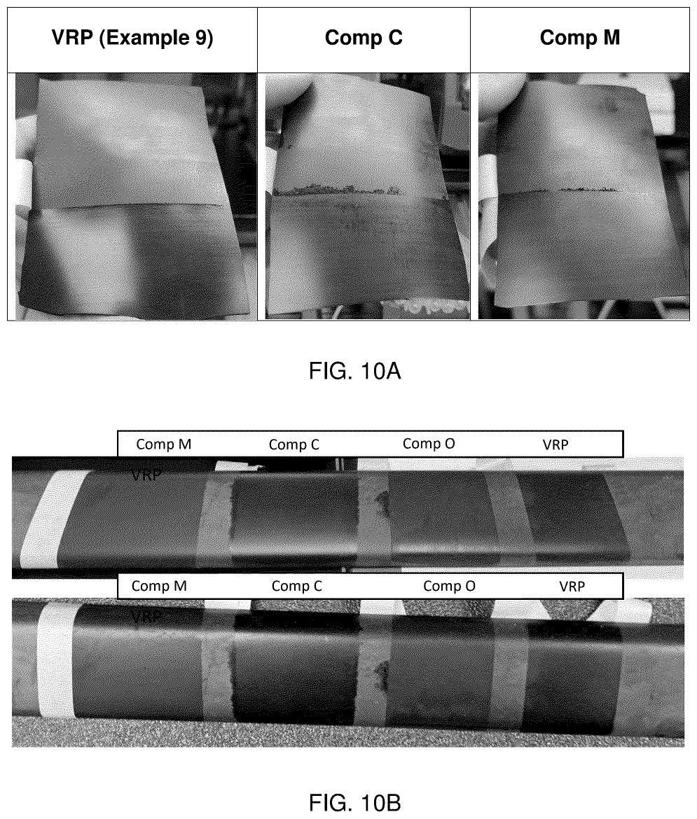

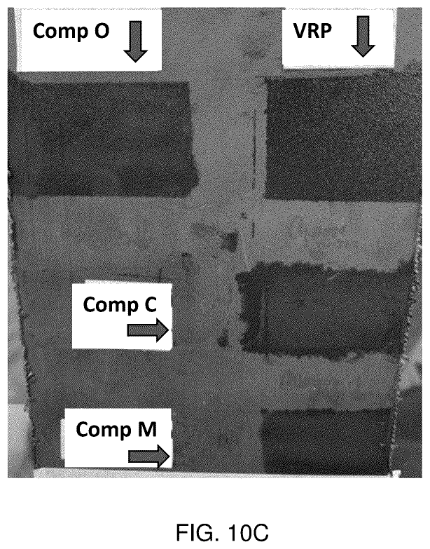

The VRP composition of Example 9 was shown to perform better (showing high shine) compared to other compositions on the market. FIGS. 10A, 10B, and 10C show comparative testing of the VRP composition of Example 9 applied on rubber (10A), plastic trim (10B), and plastic bumper (10C) compared with compositions on the market (Comp C, Comp M, and Comp O) applied on the same materials. provides higher shine than those compositions on the market applied on the same materials. Visually, the gloss of VRP is higher than Comp C, Comp M, and Comp O on some plastics, rubber, and vinyl.

The VRP composition of Example 9 was shown to help prevent surface scratches and scuffs. Coefficient of friction was tested and the results are shown in Table 9. Slip resistance is shown in Table 10.

TABLE 9
% Decrease/Increase of Coefficient of
Friction after Product Application

| | VRP Formula |
|---|---|
| Vinyl | −47.1% |
| Rubber | −29.9% |
| Plastic | −42.9% |

TABLE 10
Slip Resistance: Coefficient of Friction (PTV)

| | Vinyl | Rubber | Plastic |
|---|---|---|---|
| untreated | 68.47 | 69.20 | 83.87 |
| treated | 43.07 | 49.87 | 39.07 |

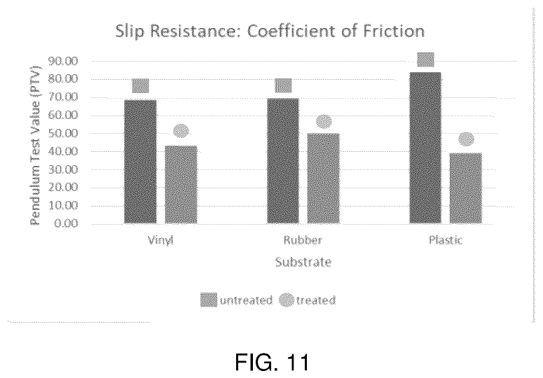

FIG. 11 illustrates the VRP composition applied on vinyl, rubber, and plastic imparts a lower Coefficient of Friction as compared to respective untreated materials indicating that VRP can prevent scratches and scuffs. When the coefficient of friction decreases, objects have the opportunity to slide or glide off a surface rather than catch on the surface causing a scratch. Test the Coefficient of Friction using the British Pendulum Test. Supporting Data: To show that VRP helps e scratches and scuffs, the coefficient of friction of recorded before and after product application. Friction is the resisting force between objects. When there is a large amount of force needed to get one object to slide across another object then there is more chance of a scratch or scuff to occur. The coefficient of friction is “the ratio of the frictional force resisting the motion of two surfaces in contact to the normal force pressing the two surfaces together.” British Pendulum Tester equipment measures the Pendulum Test Value (PTV) of slip resistance which correlates with coefficient of Friction (Coef). Ultimately, the smaller the PTV, the lower the Coef meaning there is less force resisting the motion of one surface on the surface.

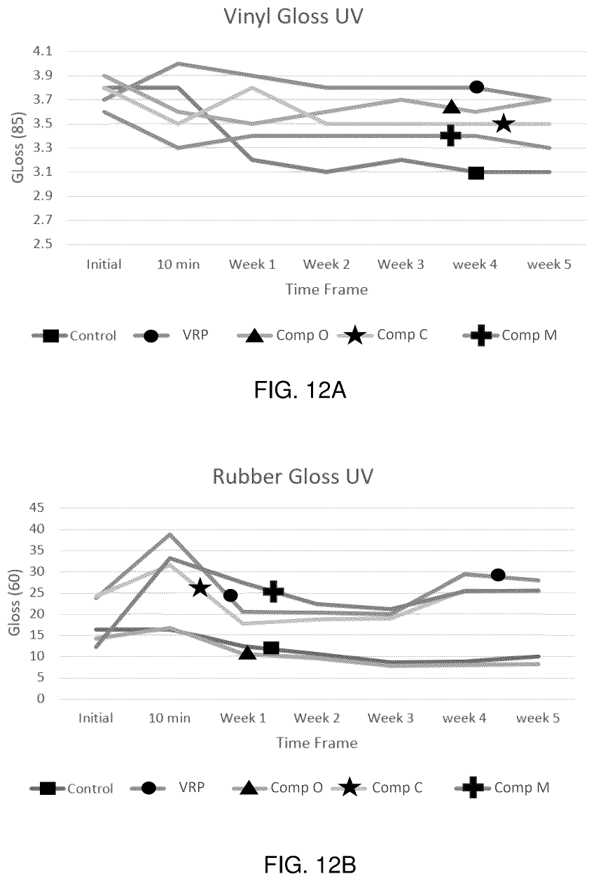

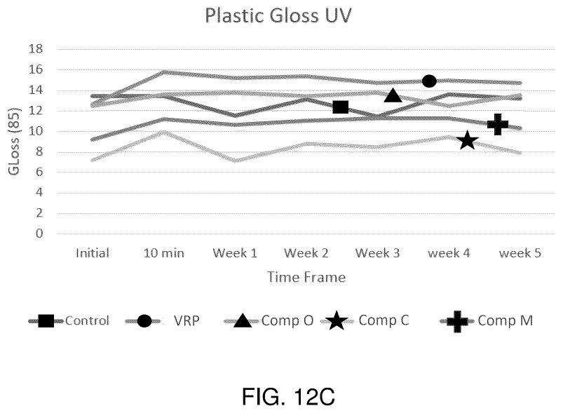

The VRP composition of Example 9 was shown to protect against UV radiation. FIGS. 12A, 12B, and 12C show UV protection of vinyl (FIG. 12A, 85 degree angle), rubber (FIG. 12B, 60 degree angle), and plastic (FIG. 12C, 85 degree angle) by composition based on gloss measurements over a period of 5 weeks. The substrates were tested for gloss value before application (initial) and either treated with the VRP composition of Example 9, a composition on the market (Comp O, Comp C, and Comp M), or left untreated (control), and tested again after 10 minutes, and then each consecutive week after being placed under UV lighting for five weeks (24 hours a day and 7 days a week). For each substrate, the gloss retention by the substrates treated with VRP was higher than the untreated substrates (control) at each measurement following treatment. For each substrate, the gloss retention by the substrates treated with VRP was higher than, or equal to, those treated with comparative examples (Comp O, Comp C, and Comp M) after five weeks under UV lights.

Gloss Differences after 5 weeks under UV radiation are shown in Table 11.

TABLE 11

| Product | Vinyl | Rubber | Plastic |
|---|---|---|---|
| Control | −0.7 | −6.5 | −0.2 |
| VRP (Example 9) | 0.0 | 4.3 | 2.1 |
| Comp O | −0.2 | −6.0 | 1.0 |
| Comp C | −0.3 | 1.1 | 0.7 |
| Comp M | −0.3 | 13.5 | 1.1 |

The treated substrates' gloss values stayed above the untreated values throughout the duration of the testing. Because the gloss stayed above the substrates' untreated values, it shows the VRP helps the substrates stay protected from UV rays. The Untreated substrate (control) saw gloss loss after five weeks under the UV light.

The VRP composition of Example 9 was shown to be non-greasy and dry to the touch.

Wiping the product with a glove 10 minutes after application showed that a person can run their finger across the areas where product was applied, and it will not smear to other areas. Product will not get on the fingers of the consumer where the finger runs across product applied areas and then across an area (rubber).

All publications, patents and patent applications cited in this specification are incorporated herein by reference in their entireties as if each individual publication, patent, or patent application were specifically and individually indicated to be incorporated by reference. While the foregoing has been described in terms of various embodiments, the skilled artisan will appreciate that various modifications, substitutions, omissions, and changes may be made without departing from the spirit thereof.

1. A composition comprising:
at least two silicone fluids: a first silicone fluid and a second silicone fluid;
one or more mineral oils;
one or more rheology modifiers;
one or more hydrocarbon solvents; and
water; and
optionally one or more preservatives.

2. The composition of claim 1, wherein the composition comprises by total weight of the composition:
about 1% to 20% of the at least two silicone fluids;
about 0.1% to 5% of the one or more mineral oils;
about 0.5% to 5% of the one or more rheology modifiers;
about 0.5% to 5% of the one or more hydrocarbon solvents; and
about 75% to 95% of water; and
optionally about 0.01% to 0.5% of the one or more preservatives.

3. The composition of claim 1, wherein the composition comprises by total weight of the composition: about at least 0.1% to 5% of the first silicone fluid and about at least 2% to 6% of the second silicone fluid.

4. The composition of claim 1, wherein the first silicone fluid has a viscosity of about 100 centistokes (cSt) to 500 cSt, 200 cSt to 450 cSt, or 300 cSt to 400 cSt, and the second silicone fluid has a viscosity of about 10,000 to 15,000 cSt, 11,000 to 14,500 cSt, 11,500 to 14,000 cSt, or 12,000 to 13,000 cSt, and optionally, wherein the first silicone fluid has a viscosity of about 350 cSt and the second silicone fluid has a viscosity of about 12,500 cSt.

5. The composition of claim 1, wherein the silicone fluids comprise silicone oils having the formula: 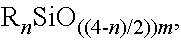
wherein:
n is 0 to 3;
m is 2 or greater; and
R is alkyl, alkylene, allyl, aryl, benzyl, phenyl, amine, amide, vinyl, fluoroalkyl, perfluoroalkane, carboxyester, or quaternary alkyl ammonium.

6. The composition of claim 1, wherein the silicone fluids comprise silicone oils comprising polydialkylsiloxanes; and optionally wherein the polydialkylsiloxanes comprise polydimethylsiloxanes.

7. The composition of claim 1, wherein the one or more mineral oils comprise mineral synthetic oil and/or mineral oil obtained from petrochemicals.

8. The composition of claim 1, wherein the one or more rheology modifiers comprise acrylate and acrylamide copolymers.

9. The composition of claim 1, wherein the one or more hydrocarbon solvents comprise hydrotreated light petroleum distillates, alcohol hydrocarbon solvents, or a combination thereof, and optionally, wherein the one or more hydrocarbon solvents comprise hydrotreated isoparaffins and naphthenics.

10. The composition of claim 1, wherein the one or more preservatives comprise a hydantoin germicide, a carbamate fungicide, benzisothiazolinone (BIT), methylisothiazolinone (MIT), or methylchloroisothiazolinone (CMIT), or a combination thereof, and optionally, wherein the one or more preservatives comprise a combination of BIT, MIT, and CMIT.

11. The composition of claim 1, wherein the composition comprises silicone fluid of about 350 cSt, silicone fluid of about 12,500 cSt, mineral oil obtained from petrochemicals, acrylate and acrylamide copolymers, a mixture of hydrotreated isoparaffins and naphthenics, and water; and optionally a preservative comprising BIT, MIT, and CMIT.

12. A method of preparing the composition of claim 1, wherein the method comprises:
(i) slowly adding the one or more hydrocarbon solvents to the water that is moving at a slow speed to form a solution;
(ii) mixing the solution for a period of time at the slow speed, and optionally increasing the speed;
(iii) continue mixing and adding the one or more rheology modifiers to the solution and mixing for a period of time; and
(iv) continue mixing and adding to the solution of step (iii) in the following order: (i) one or more mineral oils; and (ii) one or more silicone fluids, wherein the first silicone fluid is added before the second fluid; and optionally adding the one or more preservatives; and
(v) continue mixing for a period of time, thereby obtaining the composition of claim 1.

13. The method of claim 12, wherein a period of time is about 3 to 30 minutes, 5 to 25 minutes, 5, to 15 minutes, or 5 to 10 minutes.

14. The method of claim 12, wherein slow speed for mixing is about 100 to 250 revolutions per minute (rpm), and/or wherein maximum speed for mixing is about 450 rpm.

15. The method of claim 12, wherein the method further comprises dispensing the composition in a container.

16. A method of protecting a surface, wherein the method comprises applying the composition of claim 1 to a surface to form a coating, and wherein the surface is rubber or plastic.

17. The method of claim 16, wherein the plastic is vinyl.

18. The method of claim 16, wherein the surface is a surface of a vehicle.

19. The method of claim 16, wherein the surface is the surface of a dashboard, convertible tops, door lining, bumper, truck bed covers, rocker panels, weatherstripping, or door trim.

20. The method of claim 16, wherein the coating remains on the surface for about 5 to 20 washes, about 7 to 15 washes, or about 10 to 13 washes.

21. The method of claim 16, wherein the coating remains on the surface for 3 to 24 months, 3 to 18 months, 3 to 15 months, 6 to 15 months, or 6 to 12 months.

22. The method of claim 16, wherein the surface is hydrophobic.

23. The method of claim 16, wherein the surface has a higher gloss value and/or lower color depth value than a surface that has not been applied with the composition.
